(19) United States
(12) Patent Application Publication
(10) Pub. No.: US 2011/0250868 A1
(43) Pub. Date: Oct. 13, 2011

(54) METHOD, SERVER, AND SYSTEM FOR CONFIGURING PAGING GROUP AND NEIGHBOR CELL LIST OF FEMTO ACCESS POINT

(75) Inventors: Chenghui Peng, Shanghai (CN); Wei Zhang, Shanghai (CN); Yuan Lin, Shanghai (CN); Liang Gu, Chengdu (CN)

(73) Assignee: Huawei Technologies Co., Ltd., Shenzhen (CN)

(21) Appl. No.: 13/169,766

(22) Filed: Jun. 27, 2011

Related U.S. Application Data
(63) Continuation of application No. PCT/CN2009/075293, filed on Dec. 3, 2009.

(30) Foreign Application Priority Data
Dec. 29, 2008 (CN) 200810247008.2

(51) Int. Cl. H04W 4/08; H04W 12/06

(52) U.S. Cl. 455/411; 455/410

(57) ABSTRACT

A method, a server, and a system for configuring a paging group (PG) and a neighbor cell list of a femto access point (FAP) are provided. The method includes: receiving a configuration request from a security gateway or an FAP; acquiring location information of the FAP; determining an access service network gateway (ASN-GW) accessed by the FAP, and notifying the location information of the FAP to the ASN-GW, so that the ASN-GW allocates a PG to the FAP according to the location information of the FAP, and delivers an identifier (ID) of the allocated PG; and receiving the ID of the PG from the ASN-GW, and delivering the ID of the PG to the FAP. Therefore, the FAP can dynamically join into a PG and the neighbor cell list can be dynamically updated.

### CROSS-REFERENCE TO RELATED APPLICATIONS

This application is a continuation of International Application No. PCT/CN2009/075293, filed on Dec. 3, 2009, which claims priority to Chinese Patent Application No. 200810247008.2, filed on Dec. 29, 2008, both of which are hereby incorporated by reference in their entireties.

### FIELD OF THE DISCLOSURE

The present disclosure relates to mobile communications technologies, and in particular, to a method, a server, and a system for configuring a paging group (PG) and a neighbor cell list of a femto access point (FAP).

### BACKGROUND

In terms of power from small to large, base stations (BSs) include a femto BS, a pico BS, a micro BS, and a macro BS. Coverage areas of multiple BSs may form a group, and the group is called a PG. When a terminal moves within a PG, the terminal is not required to be activated in a BS, and when the terminal moves to a BS outside the PG, the terminal is required to be activated in the BS, and a BS handover is implemented. An FAP is a low-power BS, and is mainly used for small-scale signal coverage. FAPs are normally deployed by users, so that distribution of the FAPs is changing dynamically, and the number of the FAPs is enormous. A system that consists of FAPs and other network entities providing necessary functional support for users to access a radio network through the FAPs is a femtocell. Access networks other than femtocells are macro networks. When a terminal moves from a femtocell to a macro network, and if an FAP is not in a current PG of the macro network, the terminal is required to be handed over from the FAP to a BS of the macro network, which have a great impact on the BS in the macro network because the number of the FAPs is enormous. Therefore, the FAP needs to be added to the current PG. Presently, relationship information of BSs and a neighbor cell list on each of the BSs included in the current PG is pre-planned before being statically configured on a gateway or the BS.

The inventors find that the prior art has at least the following problem: Because FAPs usually dynamically access a network, and the number of the FAPs is enormous, the existing scheme of static configuration cannot be used to solve the problem that it is difficult for an FAP to dynamically join into a PG and it is difficult to dynamically update the neighbor cell list of the FAP.

### SUMMARY

The present disclosure is directed to a method, a server, and a system for configuring a PG and a neighbor cell list of an FAP, so as to solve the problem that it is difficult for an FAP to dynamically join into a PG, and it is difficult to dynamically update the neighbor cell list of the FAP.

An embodiment of the present disclosure provides a method for configuring a PG of an FAP. The method includes: receiving a configuration request from a security gateway or an FAP; acquiring location information of the FAP; determining an access service network gateway (ASN-GW) accessed by the FAP, and notifying the location information of the FAP to the ASN-GW, so that the ASN-GW allocates a PG to the FAP according to the location information of the FAP, and delivers an Identifier (ID) of the allocated PG; and receiving the ID of the PG from the ASN-GW, and delivering the ID of the PG to the FAP.

An embodiment of the present disclosure provides a method for configuring a neighbor cell list of an FAP. The method includes: receiving a configuration request from a security gateway or an FAP; acquiring location information of the FAP; acquiring a cell ID of a peripheral BS of the FAP according to the location information of the FAP; and delivering the cell ID of the peripheral BS of the FAP to the FAP for configuring a neighbor cell list of the FAP to include the cell ID.

An embodiment of the present disclosure provides a method for configuring a PG of an FAP. The method includes: receiving a configuration request from a security gateway or an FAP; acquiring location information of the FAP; and determining an ASN-GW covering the location of the FAP according to the location information of the FAP, and allocating a PG to the FAP and sending an ID of the allocated PG to the FAP if no ASN-GW covers the FAP.

Another embodiment of the present disclosure provides a configuration server. The server includes: a receiving module, configured to receive a configuration request from a security gateway or an FAP; an acquiring module, configured to acquire location information of the FAP; a determining module, configured to determine an ASN-GW accessed by the FAP, and notify the location information of the FAP to the ASN-GW, so that the ASN-GW allocates a PG to the FAP according to the location information of the FAP, and delivers an ID of the allocated PG; and a sending module, configured to receive the ID of the PG from the ASN GW, and deliver the ID of the PG to the FAP.

An embodiment of the present disclosure provides a configuration server. The server includes: a receiving module, configured to receive a configuration request from a security gateway or an FAP; an acquiring module, configured to acquire location information of the FAP; a determining module, configured to acquire a cell ID of a peripheral BS of the FAP according to the location information of the FAP acquired by the acquiring module; and a sending module, configured to deliver the cell ID of the peripheral BS of the FAP acquired by the determining module to the FAP, where the cell ID is included in a neighbor cell list of the FAP.

An embodiment of the present disclosure provides a radio network system, where the system includes: a configuration server, configured to receive a configuration request from a security gateway or an FAP, acquire location information of the FAP, determine an ASN-GW accessed by the FAP, and notify the location information of the FAP to the ASN-GW; the ASN-GW, configured to allocate a PG to the FAP according to the location information of the FAP, and deliver an ID of the allocated PG to the configuration server; and the configuration server is further configured to receive the ID of the PG from the ASN-GW, and deliver the ID of the PG to the FAP.

An embodiment of the present disclosure provides a radio network system, where the system includes: a configuration server, configured to receive a configuration request from a security gateway or an FAP, acquire location information of the FAP, determine a peripheral BS of the FAP according to the location information of the FAP, allocate a cell ID to the FAP, and send the cell ID of the FAP to the peripheral BS; and the BS, configured to receive the cell ID of the FAP sent by the configuration server, and add the cell ID of the FAP into a neighbor cell list on the BS.

According to the embodiments of the present disclosure, a configuration request is received, and relationship information is dynamically configured for an FAP according to the configuration request, so that the FAP dynamically joins into a PG, and the neighbor cell list of the FAP can be dynamically updated.

### BRIEF DESCRIPTION OF THE DRAWINGS

FIG. 1 is a schematic structural view of a system according to a first Embodiment of the present disclosure;

FIG. 2 is a schematic flow chart of a method according to a second Embodiment of the present disclosure;

FIG. 3 is a schematic flow chart of a method according to a third Embodiment of the present disclosure;

FIG. 4 is a schematic flow chart of a method according to a fourth Embodiment of the present disclosure;

FIG. 5 is a schematic flow chart of a method according to a fifth Embodiment of the present disclosure;

FIG. 6 is a schematic flow chart of a method according to a sixth Embodiment of the present disclosure;

FIG. 7 is a schematic structural view of a server according to a seventh Embodiment of the present disclosure;

FIG. 8 is a schematic structural view of a system according to an eighth Embodiment of the present disclosure; and

FIG. 9 is a schematic structural view of a system according to a ninth Embodiment of the present disclosure.

### DETAILED DESCRIPTION OF THE EMBODIMENTS

The present disclosure is further described in detail with reference to the accompanying drawings and embodiments in the following.

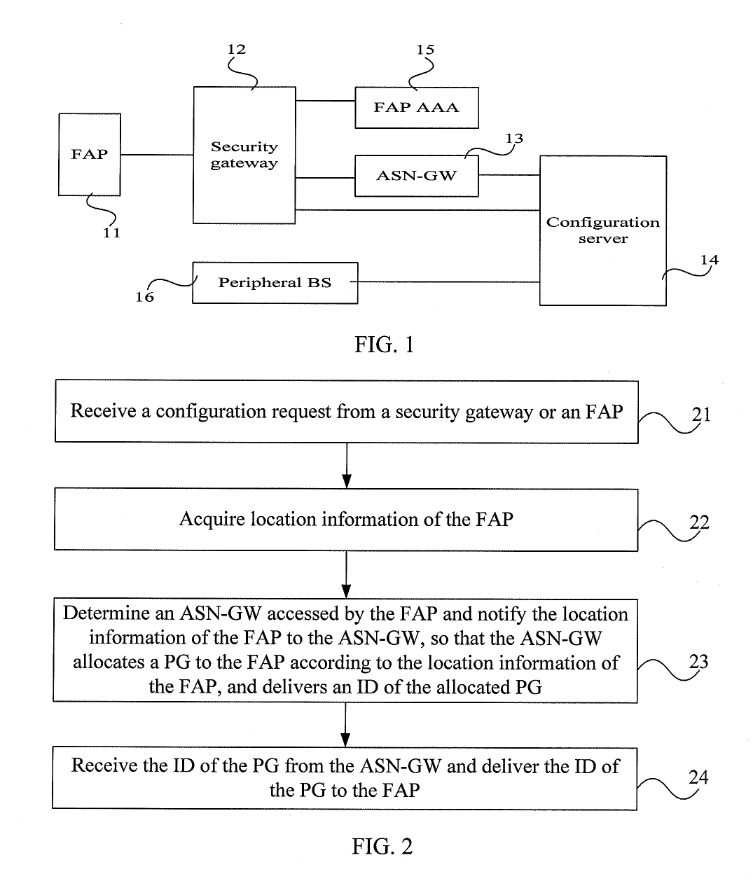

FIG. 1 is a schematic structural view of a system according to a first embodiment of the present disclosure, and the system includes an FAP 11, a security gateway 12, an ASN-GW 13, a configuration server 14, an FAP authentication, authorization, and accounting (AAA) server 15, and a peripheral BS 16 of the FAP. The security gateway 12 and the FAP 11 establish a secure communication channel, so as to guarantee security of data transmission between the FAP 11 and a radio network. The security gateway 12 may be deployed on the ASN-GW 13. The FAP AAA server saves FAP subscription data for network access authentication of the FAP.

FIG. 2 is a schematic flow chart of a method according to a second embodiment of the present disclosure, and the method is used for a scenario of configuring PG information of an FAP. According to this embodiment, the method includes the following steps:

Step 21: A configuration server receives a configuration request from a security gateway or an FAP.

Step 22: The configuration server acquires location information of the FAP.

Step 23: The configuration server determines an ASN-GW accessed by the FAP, and notifies the location information of the FAP to the ASN-GW, so that the ASN-GW allocates a PG to the FAP according to the location information of the FAP, and delivers an ID of the allocated PG.

Step 24: The configuration server receives the ID of the PG from the ASN GW, and delivers the ID of the PG to the FAP.

In this embodiment, the ASN-GW allocates the PG to the FAP, so that the FAP can dynamically join into the PG, thereby avoiding an impact incurred by BS handover when the FAP is not in the same PG with the BS.

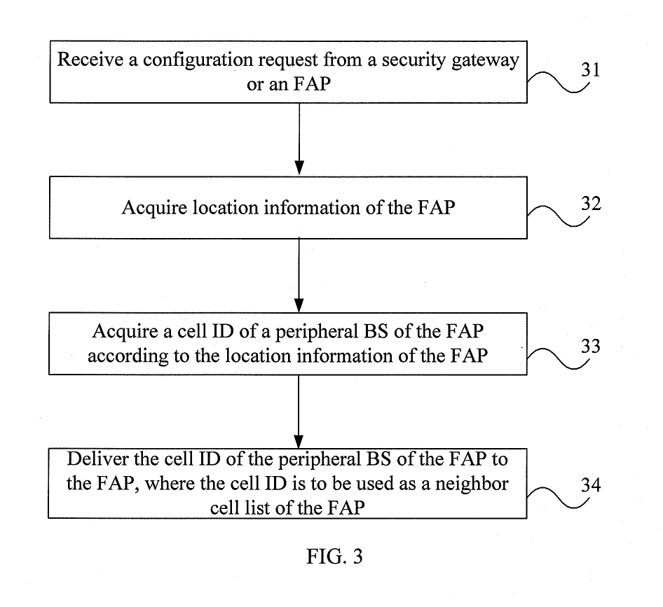

FIG. 3 is a schematic flow chart of a method according to a third embodiment of the present disclosure, and the method is used for a scenario of configuring a neighbor cell list of an FAP. According to this embodiment, the method includes the following steps:

Step 31: A configuration server receives a configuration request from a security gateway or an FAP.

Step 32: The configuration server acquires location information of the FAP.

Step 33: The configuration server acquires a cell ID of a peripheral BS of the FAP according to the location information of the FAP.

Step 34: The configuration server delivers the cell ID of the peripheral BS of the FAP to the FAP, where the cell ID is to be used as a neighbor cell list of the FAP. Accordingly, the FAP configures the neighbor cell list of the FAP to include the delivered cell ID.

In this embodiment, after the configuration request is received, the neighbor cell list of the FAP can be updated dynamically, which implements dynamic update of the neighbor cell list of the FAP, and accelerates handover process of a terminal between the FAP and another BS.

The process of dynamically configuring the PG and the process of dynamically configuring the neighbor cell list are described above respectively, and the following describes process of configuring both the PG and the neighbor cell list in a system.

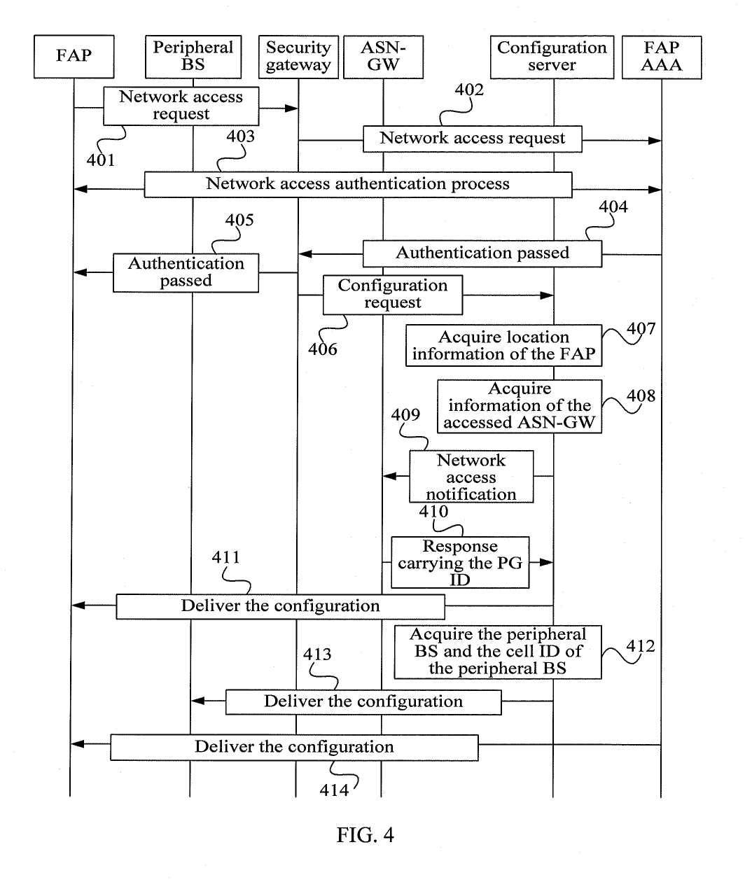

FIG. 4 is a schematic flow chart of a method according to a fourth embodiment of the present disclosure, and the method includes the following steps:

Step 401: An FAP acquires an address of a security gateway, and sends a network access request to the security gateway.

During subscription, a radio network provider, such as a Network Access Provider (NAP) or a Network Service Provider (NSP), configures the address of the security gateway on the FAP. The address may be an Internet Protocol (IP) address or an ID address (such as a Universal Resource Locator (URL) address, and an IP address is queried through a Domain Name Server (DNS)). Alternatively, the address of the security gateway may not be configured, and instead an address of a server that can acquire the address of the security gateway is configured.

Before the FAP sends the network access request to the security gateway, a data path between the FAP and the security gateway may be established in advance. In order to guarantee security of data transmission between the FAP and the security gateway, the path between the FAP and the security gateway may be an Internet Protocol SECurity extensions (IPSEC) channel.

Step 402: The security gateway forwards the network access request to an FAP AAA server.

Step 403: The FAP AAA server performs network access authentication on the FAP During the network access authentication process of the FAP, the FAP AAA server may determine whether to approve the network access request of the FAP according to the fact whether a location of the FAP is within a range permitted by a subscribed NAP or NSP of the FAP.

Step 404: If the FAP passes the authentication, the FAP AAA server returns an authentication success message to the security gateway.

Step 405: The security gateway sends the authentication success message to the FAP.

The authentication process of steps 401 to 405 guarantees the access of a required FAP to the radio network, so that an operator can manage FAPs that dynamically access the network.

Step 406: After receiving the authentication success message, the security gateway or the FAP initiates a configuration request to the configuration server. Specifically, when the security gateway sends the configuration request (as shown in the figure), no time sequence limitation relationship exists between step 405 and step 406. When the FAP sends the configuration request, step 405 shall be performed before step 406.

Step 407: After receiving the configuration request, the configuration server acquires location information of the FAP. The location information of the FAP may be carried in the configuration request, or may be acquired by the configuration server from the FAP AAA server. The location information may be coordinates of a physical location of the FAP, or a macro cell ID of a peripheral macro network of the FAP. Specifically, the location information may be acquired in the following manners:

Manner 1: The configuration server searches for an IP address and location mapping database according to the IP address information of the FAP carried in the configuration request or acquired from the FAP AAA server to acquire a physical address of the FAP. Because current IP addresses allocated by Internet Service Providers (ISPs) to users are categorized in a geographic manner, it is feasible to acquire a current access region of a user according to an IP address.

Manner 2: After being self-located, an FAP device reports location information to the security gateway, and then the security gateway carries the location information in the configuration request to be sent to the configuration server; or, the FAP directly carries the location information in the configuration request to be sent to the configuration server; or, during authentication, the FAP sends the location information to the FAP AAA server, and the configuration server acquires the location information from the FAP AAA server. For example, the FAP device is equipped with a Global Positioning System (GPS) device, so that the FAP can perform self-location to determine the location information.

Manner 3: The configuration server determines the location information of the FAP through a macro network. For example, a precise location of the FAP is determined through a location service of a macro network. Or, the FAP scans signals from a peripheral macro network and reports cell information of the peripheral macro network to the FAP AAA server, the FAP AAA server may acquire the location information of the FAP according to the cell information of the peripheral macro network, and the configuration server may acquire the location information of the FAP from the FAP AAA server.

Step 408: The configuration server acquires information of an ASN-GW accessed by the FAP according to the location information of the FAP. The information of the ASN-GW may include an IP address and/or an ID of the ASN-GW. The configuration server may query access network deployment data, acquire an ASN-GW that covers the FAP area, and determine the ASN-GW as the ASN-GW accessed by the FAP. The ASN-GW accessed by the FAP refers to a first ASN-GW connected to the FAP after the FAP, as a micro BS, accesses the radio network. A specific acquiring method may be as follows:

The configuration server queries an ASN-GW coverage area configuration table, acquires an ASN-GW with the coverage including the location of the FAP, and allocates the ASN-GW as the ASN-GW accessed by the FAP. If more than one ASN-GW meets requirements, for example, the ASN-GWs covering the FAP include a first ASN-GW and a second ASN-GW, the configuration server selects one of the two ASN-GWs as the ASN-GW accessed by the FAP according to a load balancing principle or a random allocation principle. If no ASN-GW that meets requirements is found, for example, a user uses an FAP in an area not covered by any radio network or an interconnection relationship between a radio access network provider of the used area and an NAP or an NSP that the user subscribes to is not established, the following manner may be adopted for handling: The configuration server allocates a PG to the FAP, adds the ID of the FAP into the allocated PG, sends an ID of the allocated PG to the FAP, and may also select a nearest ASN-GW or a specific ASN-GW to manage the allocated PG (in the example shown in the figure, the ASN-GW allocates the PG). Specifically, the configuration server allocates a PG to the FAP. This type of FAPs may belong to the same PG, or an FAP is allocated with a separate PG. The configuration server saves the FAP and ID information of the PG allocated to the FAP, and sends the ID of the allocated PG to the FAP. Or, the configuration server does not allocate any PG, and instead selects a nearest ASN-GW or designates a specific ASN-GW to manage this type of FAPs, and determines the designated ASN-GW as the ASN-GW accessed by the FAPs. The ASN-GW allocates a PG to this type of FAPs. The ASN-GW identifies this type of FAPs according to location information of the FAPs. When the ASN-GW allocates the PG to the FAP, this kind of FAPs may belong to the same PG, or an FAP is allocated with a separate PG. The ASN-GW saves the FAP and ID information of the PG allocated to the FAP, and returns an allocation result to the configuration server. In the example shown in the figure, the ASN-GW allocates the PG.

The ASN-GW coverage area configuration table may be shown as Table 1.

TABLE 1

| | | | NAP |
|---|---|---|---|
| | | | of the |
| ASN-GW Name | ASN-GW Address | ASN-GW Coverage | ASN-GW |
| First ASN-GW | 10.70.112.112 | A (Longitude a, Latitude a) | First NAP |
| | | B (Longitude b, Latitude b) | |
| | | C (Longitude c, Latitude c) | |
| | | D (Longitude d, Latitude d) | |

Table 1 is an exemplary description of mapping relationships between ASN-GW coverage areas and ASN-GWs, and not intended to limit values of the ASN-GW coverage area configuration table. The coverage area is described by using a simple rectangular/square area defined by four points as an example. During actual implementation, a polygon may be used to describe an area. How to judge whether a specific point (the longitude and the latitude) is in a polygonal area is a matter of specific mathematical algorithms, which is not described in detail herein.

Step 409: The configuration server sends a network access notification message to the ASN-GW accessed by the FAP.

After determining the ASN-GW accessed by the FAP, the configuration server sends the network access notification message of the FAP to the ASN-GW accessed by the FAP. The network access notification message carries the location information of the FAP, and may also carry the ID of the FAP. The ASN-GW accessed by the FAP allocates a PG to the FAP according to the location information of the FAP, and enables the FAP to join into the allocated PG. The following scenarios are involved:

1) If the ASN-GW has only one PG, or, in other words, BSs of the ASN-GW accessed by the FAP all belong to the same PG, the ASN-GW directly allocates the ID of the unique PG to the FAP, and adds the ID of the FAP to the allocated PG.

2) If the BSs of the ASN-GW belong to two or more PGs, the ASN-GW allocates to the FAP a PG covering the location of the FAP according to the location information of the FAP and geographic distribution of physical locations of the multiple PGs, in which the number of the PGs allocated to the FAP may be one or more. The ASN-GW adds the ID of the FAP to the allocated one or more PGs.

3) If the ASN-GW does not manage the PG, the PG is managed by another ASN-GW which is accepted by the ASN-GW. For example, if multiple ASN-GWs all belong to the same PG, one of the ASN-GWs manages the PG, and the other ASN-GWs are in the PG. Then, the ASN-GW sends a request to the ASN-GW managing the PG, and requests for PG allocation of the FAP and joining of the FAP into the allocated PG. The foregoing manners 1 and 2 are applied. The ASN-GW managing the PG sends an allocation result to the ASN-GW accessed by the FAP, that is, sends the ID of the allocated PG to the accessed ASN-GW.

Step 410: The ASN-GW sends a response message to the configuration server, where the message carries the ID of the PG allocated by the ASN-GW accessed by the FAP to the FAP.

Step 411: The configuration server delivers configuration information to the FAP, and delivers the ID of the PG to the FAP. The configuration information may further include an address or ID of an allocated ASN-GW.

Through steps 409 to 411, the PG saves the information of the FAP, and the FAP saves the information of the PG, so that the FAP dynamically joins into the PG.

In order to further narrow a paging range to page a terminal more quickly after the terminal moves, in this embodiment, neighbor cell list information may be further configured.

Step 412: The configuration server queries access network deployment data according to the location information of the FAP to acquire a peripheral BS of the FAP and a cell ID of the peripheral BS.

The algorithm for acquiring the peripheral BS of the FAP is similar to the algorithm for acquiring the ASN-GW. The peripheral BS covering the location of the FAP is determined according to the coverage of the peripheral BS and the location of the FAP. The number of the peripheral BS that meets requirements may be 0, 1, or multiple. The configuration server acquires a cell of a peripheral BS of the FAP according to the location information of the FAP, where the cell may be a macro BS cell or a femto BS cell, and the number may be one or multiple.

Step 413: The configuration server delivers configuration information to the peripheral BS, and adds the cell ID of the FAP to the neighbor cell list on the peripheral BS. The cell ID of the FAP may be a unique ID allocated by the configuration server to the FAP, and a format of the cell ID of the FAP is the same as the format of a BS cell ID used in a World Interoperability for Microwave Access (WiMAX) network. The configuration server may directly deliver the configuration information to the BS, or the configuration server may deliver the configuration information to the BS through the ASN-GW.

Step 414: The configuration server delivers the configuration information to the FAP, and delivers the cell ID of the peripheral BS to the FAP, where the cell ID is to be used as the neighbor cell list of the FAP. The configuration server may directly deliver the configuration information to the BS, or the configuration server may deliver the configuration information to the BS through the ASN-GW.

Through steps 412 to 414, the neighbor cell list on the peripheral BS saves the information of the FAP, and the neighbor cell list of the FAP saves the information of the PG, so that the peripheral BS dynamically updates the neighbor cell list.

No time sequence limitation relationship exists between steps 409 to 411 and steps 412 to 414, and in addition, when both of the PG and the neighbor cell are configured, the configuration server may update the ID of the PG on the FAP and the neighbor cell list only through a message, that is, only either step 411 or step 414 is performed.

According to this embodiment, the FAP can dynamically join into the PG, and further the neighbor cell list is updated, so that the moving terminal can be paged more quickly. According to this embodiment, authentication may be implemented to guarantee dynamic joining of the FAP satisfying a subscription condition, which facilitates the management of an operator.

Through the above embodiment, the process of the FAP dynamically joining into the PG after accessing the network is illustrated. According to an embodiment of the present disclosure, a network quitting process of an FAP can be realized, so as to delete the FAP from a PG when the FAP needs to quit the network, thereby narrowing the PG range and reducing the paging overhead.

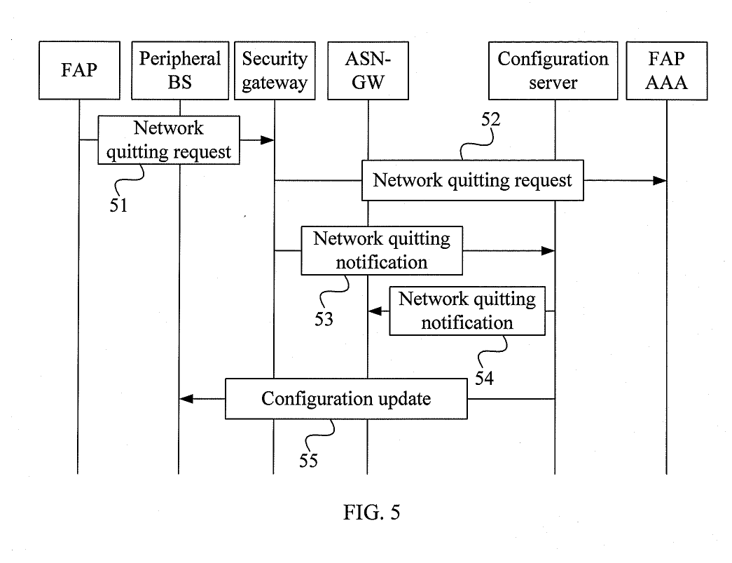

FIG. 5 is a schematic flow chart of a method according to a fifth embodiment of the present disclosure. In this embodiment, an example is taken in which an FAP takes the initiative to quit the network (such as powering off by a user). According to this embodiment, the method includes the following steps:

Steps 51 to 52: An FAP sends a network quitting request to a security gateway, and the network quitting request is sent to an FAP AAA server through the security gateway.

Step 53: After receiving the network quitting request, the security gateway sends a network quitting notification to a configuration server; or, the FAP sends the network quitting notification to the configuration server.

Step 54: The configuration server sends a network quitting notification message to an ASN-GW, and instructs the ASN-GW to delete an ID of the FAP.

If a neighbor cell list on a peripheral BS is updated when the FAP accesses the network, the method according to this embodiment may further include the following step:

Step 55: The configuration server sends a configuration update message to the peripheral BS, and instructs the peripheral BS to delete cell ID of the FAP from the neighbor cell list on the BS.

No time sequence limitation relationship exists between step 54 and step 55.

The network quitting process is illustrated in this embodiment. After the FAP quits the network, related information of the FAP in the ASN-GW and the peripheral BS may be deleted, resource occupation on the devices is reduced, and the FAP is no longer paged to save the paging overhead.

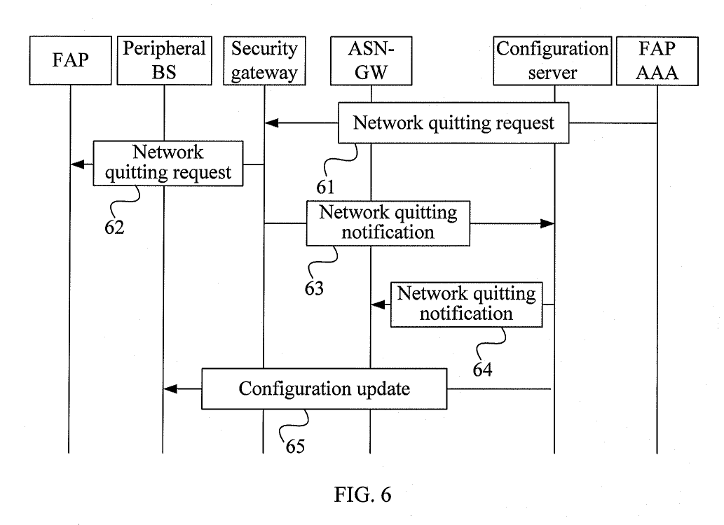

FIG. 6 is a schematic flow chart of a method according to a sixth embodiment of the present disclosure. The difference between this embodiment and the third embodiment is that: In this embodiment, a network quitting request is initiated at a network side (for example, when the charge of a user is overdue). According to this embodiment, the method includes the following steps:

Steps 61 to 62: An FAP AAA server initiates a network quitting request to an FAP through a security gateway.

Steps 63 to 65 are the same as steps 53 to 55 in the third embodiment, which will not be repeated herein.

The network quitting process is illustrated in this embodiment. After the FAP quits the network, related information of the FAP in the ASN-GW and the peripheral BSs may be deleted, resource occupation on the devices is reduced, and the FAP is no longer paged to save the paging overhead.

Persons of ordinary skill in the art should understand that, all or a part of the steps of the method according to the embodiments may be implemented by a program instructing relevant hardware. The program may be stored in a computer readable storage medium. When the program is executed, the steps of the method according to the embodiments are performed. The storage medium may be any medium capable of storing program codes, such as a readable only memory (ROM), a readable access memory (RAM), a magnetic disk, or a compact disk.

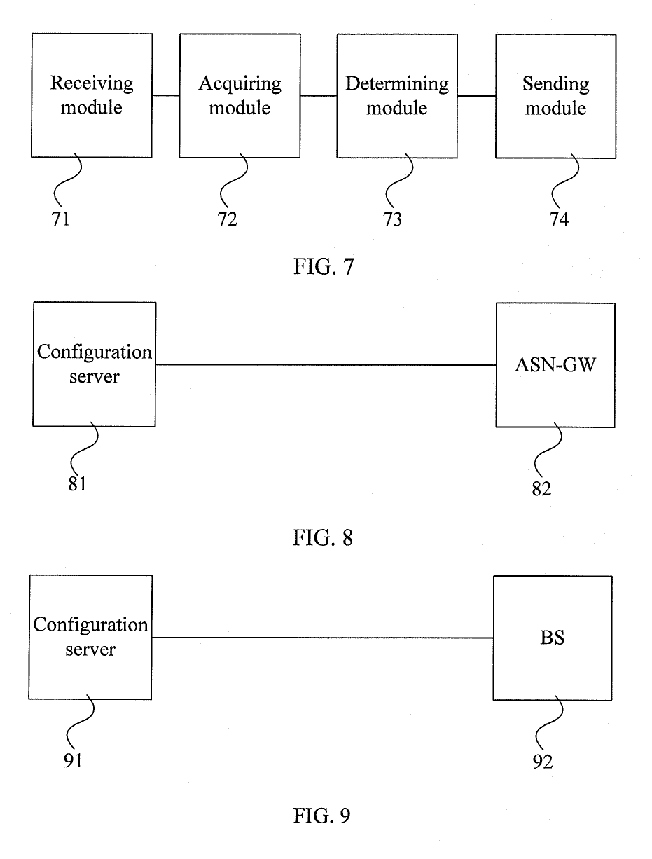

FIG. 7 is a schematic structural view of a server according to a seventh embodiment of the present disclosure.

In accordance with the fourth embodiment of the method, a configuration server is provided, which includes a receiving module 71, an acquiring module 72, a determining module 73, and a sending module 74. The receiving module 71 is configured to receive a configuration request from a security gateway or an FAP. The acquiring module 72 is configured to acquire location information of the FAP. The determining module 73 is configured to determine an ASN-GW accessed by the FAP, and notify the location information of the FAP acquired by the acquiring module 72 to the ASN-GW, so that the ASN-GW allocates a PG to the FAP according to the location information of the FAP, and delivers an ID of the allocated PG. The sending module 74 is configured to receive the ID of the PG from the ASN GW, and deliver the ID of the PG to the FAP.

In accordance with the fifth embodiment of the method, a configuration server is provided. Referring to FIG. 7, the configuration server includes a receiving module 71, configured to receive a configuration request from a security gateway or an FAP; an acquiring module 72, configured to acquire location information of the FAP; a determining module 73, configured to acquire a cell ID of a peripheral BS of the FAP according to the location information of the FAP acquired by the acquiring module 72; and a sending module 74, configured to deliver the cell ID of the peripheral BS of the FAP acquired by the determining module 73 to the FAP, where the cell ID is included in a neighbor cell list of the FAP.

In accordance with a configuration server allocating a PG to an FAP, according to an embodiment of the present disclosure, a configuration server is provided, which includes a receiving module 71, configured to receive a configuration request from a security gateway or an FAP; an acquiring module 72, configured to acquire location information of the FAP; a determining module 73, configured to determine an ASN-GW covering the location of the FAP according to the location information of the FAP, and allocate a PG to the FAP if no ASN-GW covers the FAP; and a sending module 74, configured to send an ID of the PG allocated by the determining module to the FAP.

In the above three embodiments, the acquiring of the location information of the FAP includes: acquiring the location information from the configuration request when the configuration request carries the location information of the FAP; or acquiring the location information of the FAP from the AAA server; or acquiring an IP address of the FAP from the configuration request or the AAA server, and acquiring the location information of the FAP according to the IP address.

In this embodiment, the ASN-GW allocates the PG to the FAP, so that the FAP dynamically joins into the PG, thereby avoiding an impact incurred by BS handover when the BSs are not in the same PG. Alternatively, in this embodiment, after the configuration request is received, the neighbor cell list of the FAP can be updated dynamically, which implements dynamic update of the neighbor cell list of the FAP, and accelerates handover of a terminal between the FAP and another BS.

FIG. 8 is a schematic structural view of a system according to an eighth embodiment of the present disclosure, and the system includes a configuration server 81 and an ASN-GW 82. The configuration server 81 is configured to receive a configuration request from a security gateway or an FAP, acquire location information of the FAP, determine an ASN-GW accessed by the FAP, and notify the location information of the FAP to the ASN-GW. The ASN-GW 82 is configured to allocate a PG to the FAP according to the location information of the FAP, and deliver an ID of the allocated PG to the configuration server. The configuration server 81 is further configured to receive the ID of the PG from the ASN-GW 82, and deliver the ID of the PG to the FAP.

Furthermore, in order to guarantee that a valid FAP accesses the radio network, an FAP, a security gateway, and an FAP AAA server may be further included according to this embodiment. The FAP is configured to send a network access request. The security gateway is configured to forward the network access request sent by the FAP to the FAP AAA server. The FAP AAA server is configured to authenticate the FAP, send an authentication success message to the security gateway after the authentication is passed, and forward through the security gateway the authentication success message to the FAP. The configuration server is specifically configured to receive the configuration request sent after by the security gateway or the FAP after the security gateway or the FAP receives the authentication success message.

In order to delete an invalid FAP in time, according to this embodiment, the FAP is further configured to send a network quitting request to the security gateway after determining to quit the network. Alternatively, the FAP AAA server is further configured to send the network quitting request to the security gateway when it is determined that the FAP needs to quit the network. The security gateway is further configured to send a network quitting notification message to the configuration server after receiving the network quitting request. Alternatively, the FAP may send the network quitting notification message to the configuration server. The configuration server is further configured to instruct the ASN-GW 72 to delete the ID of the FAP from the PG after receiving the network quitting notification. In this embodiment, the configuration request indicating that the FAP needs to join into the PG is received, so that the FAP can dynamically join into the PG.

In this embodiment, the ASN-GW allocates the PG to the FAP, so that the FAP dynamically joins into the PG, thereby avoiding an impact incurred by BS handover when the BSs are not in the same PG.

FIG. 9 is a schematic structural view of a system according to a ninth embodiment of the present disclosure, and the system includes a configuration server 91 and a BS 92. The configuration server 91 is configured to receive a configuration request from a security gateway or an FAP, acquire location information of the FAP, determine a peripheral BS of the FAP according to the location information of the FAP, allocate a cell ID to the FAP, and send the cell ID of the FAP to the peripheral BS. The BS 92 is configured to receive the cell ID of the FAP sent by the configuration server, and add the cell ID of the FAP into a neighbor cell list on the BS.

In order to guarantee that a valid FAP accesses the radio network, an FAP may be further included according to this embodiment. The FAP is configured to send a network access request. The security gateway is configured to forward the network access request sent by the FAP to an FAP AAA server. The FAP AAA server is configured to authenticate the FAP, send an authentication success message to the security gateway after the authentication is passed, and forward the authentication success message to the FAP through the security gateway. The configuration server is specifically configured to receive the configuration request sent after the security gateway or the FAP receives the authentication success message.

In order to delete an invalid FAP in time, according to this embodiment, the FAP is further configured to send a network quitting request to the security gateway after determining to quit the network. Alternatively, the FAP AAA server is further configured to send the network quitting request to the security gateway when it is determined that the FAP needs to quit the network. The security gateway is further configured to send a network quitting notification message to the configuration server after receiving the network quitting request. Alternatively, the FAP may send the network quitting notification message to the configuration server. The configuration server is further configured to instruct the BS to delete the cell ID of the FAP from the neighbor cell list on the BS after receiving the network quitting notification.

In this embodiment, after the configuration request is received, the neighbor cell list of the FAP can be updated dynamically, which implements dynamic update of the neighbor cell list of the FAP, and accelerates handover of a terminal between the FAP and another BS.

Finally, it should be noted that the above embodiments are merely provided for describing the present disclosure, but not intended to limit the present disclosure. It should be understood by persons of ordinary skill in the art that although the present disclosure has been described in detail with reference to the preferred embodiments, modifications or equivalent replacements can be made to the present disclosure, and such modifications or replacements do not cause the essence of corresponding solutions to depart from the spirit and scope of the present disclosure.

What is claimed is:

1. A method for configuring a paging group (PG) of a femto access point (FAP), comprising:
receiving a configuration request from a security gateway or an FAP;
acquiring location information of the FAP;
determining an access service network gateway (ASN-GW) accessed by the FAP, and notifying the location information of the FAP to the ASN-GW, so that the ASN-GW allocates a PG to the FAP according to the location information of the FAP, and delivers an identifier (ID) of the allocated PG; and
receiving the ID of the PG from the ASN-GW, and delivering the ID of the PG to the FAP.

2. The method according to claim 1, wherein acquiring the location information of the FAP comprises one of the following:
acquiring the location information from the configuration request when the configuration request comprises the location information of the FAP;
acquiring the location information of the FAP from an authentication, authorization, and accounting (AAA) server; and
acquiring an IP address of the FAP from the configuration request or the AAA server, and acquiring the location information of the FAP according to the IP address.

3. The method according to claim 1, wherein determining the ASN-GW accessed by the FAP comprises one of the following:
querying access network deployment data according to the location information of the FAP, acquiring an ASN-GW covering an area of the FAP, and determining the ASN-GW as the ASN-GW accessed by the FAP; and
designating an ASN-GW for the FAP as the ASN-GW accessed by the FAP, if no ASN-GW covering the area of the FAP is found.

4. The method according to claim 1, wherein notifying the location information of the FAP to the ASN-GW comprises: sending a network access notification message to the ASN-GW, wherein the network access notification message comprises the location information of the FAP.

5. The method according to claim 4, wherein the network access notification message further comprises an ID of the FAP, and the method further comprises: adding, by the ASN-GW, the ID of the FAP to the allocated PG.

6. The method according to claim 1, wherein allocating the PG to the FAP according to the location information of the FAP comprises one of the following:
allocating, by the ASN-GW, a PG managed by the ASN-GW to the FAP, if the ASN-GW has the PG;
allocating a PG covering the location of the FAP to the FAP according to the location information of the FAP, if the ASN-GW has two or more PGs managed by the ASN-GW; and
determining, by the ASN-GW, an ASN-GW managing a PG where the accessed ASN-GW is located when the ASN-GW does not have any PG managed by the ASN-GW itself, and requesting the ASN-GW managing the PG to allocate a PG to the FAP, and sending an ID of the allocated PG to the ASN-GW accessed by the FAP.

7. The method according to claim 5, further comprising:
receiving a network quitting notification from the security gateway or the FAP; and
sending the network quitting notification to the ASN-GW accessed by the FAP, and instructing the accessed ASN-GW to delete the ID of the FAP from the PG managed by the ASN-GW.

8. A method for configuring a neighbor cell list of a femto access point (FAP), comprising:
receiving a configuration request from a security gateway or an FAP;
acquiring location information of the FAP;
acquiring a cell identifier (ID) of a peripheral base station (BS) of the FAP according to the location information of the FAP; and
delivering the cell ID of the peripheral BS of the FAP to the FAP for configuring a neighbor cell list of the FAP to include the cell ID.

9. The method according to claim 8, further comprising:
determining the peripheral BS of the FAP according to the location information of the FAP; and
allocating a cell ID to the FAP, and sending the cell ID of the FAP to the peripheral BS, so that the peripheral BS adds the cell ID of the FAP to a neighbor cell list on the peripheral BS.

10. The method according to claim 8, further comprising:
receiving a network quitting notification from the security gateway or the FAP; and
sending a configuration update message to the peripheral BS of the FAP, and instructing the peripheral BS to delete the cell ID of the FAP from the neighbor cell list on the peripheral BS.

11. A configuration server, comprising:
a receiving module, configured to receive a configuration request from a security gateway or a femto access point (FAP);
an acquiring module, configured to acquire location information of the FAP;
a determining module, configured to determine an access service network gateway (ASN-GW) accessed by the FAP, and notify the location information of the FAP to the ASN-GW, so that the ASN-GW allocates a paging group (PG) to the FAP according to the location information of the FAP, and delivers an identifier (ID) of the allocated PG; and
a sending module, configured to receive the ID of the PG from the ASN GW, and deliver the ID of the PG to the FAP.

12. A configuration server, comprising:
a receiving module, configured to receive a configuration request from a security gateway or a femto access point (FAP);
an acquiring module, configured to acquire location information of the FAP;
a determining module, configured to acquire a cell identifier (ID) of a peripheral base station (BS) of the FAP according to the location information of the FAP acquired by the acquiring module; and
a sending module, configured to deliver the cell ID of the peripheral BS of the FAP acquired by the determining module to the FAP, wherein the cell ID is included in a neighbor cell list of the FAP.

13. A radio network system, comprising:
a configuration server, configured to receive a configuration request from a security gateway or a femto access point (FAP), acquire location information of the FAP, determine an access service network gateway (ASN-GW) accessed by the FAP, and notify the location information of the FAP to the ASN-GW;
the ASN-GW, configured to allocate a paging group (PG) to the FAP according to the location information of the FAP, and deliver an identifier (ID) of the allocated PG to the configuration server; and
the configuration server is further configured to receive the ID of the PG from the ASN-GW, and deliver the ID of the PG to the FAP.

14. A radio network system, comprising:
a configuration server, configured to receive a configuration request from a security gateway or a femto access point (FAP), acquire location information of the FAP, determine a peripheral base station (BS) of the FAP according to the location information of the FAP, allocate a cell identifier (ID) to the FAP, and send the cell ID of the FAP to the peripheral BS; and
the BS, configured to receive the cell ID of the FAP sent by the configuration server, and add the cell ID of the FAP to a neighbor cell list on the BS.
